(19) United States
(12) Patent Application Publication
(10) Pub. No.: US 2018/0174172 A1
(43) Pub. Date: Jun. 21, 2018

(54) DETERMINING ATTRIBUTES OF ONLINE SYSTEM USERS WITHIN A THRESHOLD DISTANCE OF A PHYSICAL LOCATION DURING A SPECIFIED TIME INTERVAL

(71) Applicant: Facebook, Inc., Menlo Park, CA (US)

(72) Inventors: Charles Joseph Hughes, San Francisco, CA (US); Alexandra Louise Krakaris, Orinda, CA (US)

(21) Appl. No.: 15/387,499

(22) Filed: Dec. 21, 2016

(51) Int. Cl. G06Q 30/02

(52) U.S. Cl. CPC G06Q 30/0205; G06Q 30/0242; G06Q 30/0276

(57) ABSTRACT

An online system receives information from client devices describing locations of the client devices and associates locations of various client devices with various online system users. The online system identifies a group of users who were within a threshold distance of a physical location associated with content maintained by the online system, retrieves attributes maintained by the online system in association with users of the group, and generates data describing characteristics of the attributes. Based on the generated data, the online system generates a report describing the group of users and visits by the group of users to a geographic area within the threshold distance of the physical location. The report is provided to a user associated with the content or with the physical location to provide information about users associated with locations within the threshold distance of the physical location.

### BACKGROUND

This disclosure relates generally to online systems, and more specifically to analytic reports generated by an online system.

Online systems, such as social networking systems, allow users to connect to and to communicate with other users of an online system. Users may create profiles on an online system that are tied to their identities and include information about the users, such as interests and demographic information. The users may be individuals or entities such as corporations or charities. Online systems allow users to easily communicate and to easily share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow publishing users (e.g., businesses) to sponsor presentation of content on an online system to gain public attention for a publishing user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the user. Frequently, an online system charges a publishing user for each presentation of sponsored content to an online system user or for each interaction with sponsored content by an online system user. For example, an online system receives compensation from a publishing user each time a content item provided to the online system by the publishing user is displayed to another user on the online system or each time another user is presented with the content item provided by the publishing user via the online system and interacts with the content item (e.g., selects a link included in the content item), or each time another user performs one or more particular actions after being presented with the content item provided by the publishing user (e.g., visits a website or physical location associated with the publishing user).

Publishing users who sponsor presentation of content by an online system often seek to leverage information maintained by the online system to increase the likelihood that users presented with the sponsored content will be interested in the sponsored content and subsequently perform an action in response to being presented with the sponsored content. For example, a publishing user sponsoring presentation of content on an online system encouraging users to subscribe to a newsletter seeks to increase a likelihood of the sponsored content being presented to online system users likely to subscribe to the newsletter by targeting presentation of the sponsored content to online system users having characteristics matching characteristics of other online system users who subscribe to similar newsletters. As another example, publishing users who sponsor presentation of content associated with a physical location leverage information describing characteristics of users who visited the physical location to target presentation of the sponsored content to additional users having characteristics matching or similar to characteristics of the users who visited the physical location, increasing a likelihood of the sponsored content being presented to additional users who visit the physical location. For example, if a majority of online system users who visit a sporting goods store are users between the ages of 18 and 24 who have declared an interest in a particular baseball team, a publishing user associated with the store may target additional users between the ages of 18 and 24 who have declared an interest in the particular baseball team to receive content about the store on the online system, so a likelihood of content about the store being presented to users who will be interested in the content and who will visit the store in response to being presented with the content is increased.

An online system providing a publishing user with information describing users who visit a physical location associated with the publishing user or associated with content associated with the publishing user typically requires users who visited the physical location to perform an action to inform the online system that the users have visited the physical location. For example, a user who visits a particular physical location updates information associated with a user profile of the user maintained by the online system to describing the user's current location or checks-in to the physical location via an application executing on a client device associated with the user when the user visits the physical location. When users who visited the physical location performs the action informing the online system that the users visited the physical location, the online system may then retrieve information maintained by the online system describing characteristics of users who informed the online system the users have visited the location and provide the retrieved information to the publishing user associated with the physical location or associated with content associated with the physical location. For example, if a significant amount of users who regularly check-in to the sporting goods store in the previous example have declared an interest in soccer, the online system provides information indicating that users who have regularly checked-in to the sporting goods store have declared an interest in soccer to an owner of the sporting goods store. Subsequently, the owner of the sporting goods store may request that the online system present content about the store relating to soccer equipment and soccer-related apparel carried at the store.

However, determining characteristics of users who visit physical locations associated with publishing users or associated with content associated with publishing users excludes characteristics of additional users who have not visited the physical locations but who are likely to be interested in receiving the content and in visiting the physical locations. For example, users who frequently visit a neighborhood of the sporting goods store of the previous example are more likely to visit the store than users who have never visited the neighborhood, despite having not previously checked-in to the store. Moreover, the majority of online system users often fail to check-in to various locations they visit or to update user profile information maintained by the online system to reflect changes in their location. Accordingly, conventional online systems are often not informed of locations of a significant amount of users who visit physical locations associated with content presented by the online system or who would likely be interested in receiving the content. This lack of information prevents conventional online systems from meaningfully identifying characteristics of users who would likely be interested in receiving certain content or who would likely be interested in visiting physical locations associated with the certain content. Hence, a significant amount of users who are likely to be interested in content presented by the online system may not be identified, reducing the likelihood that the users will be presented with content that interests them or content that will induce them to perform a particular action in response to being presented with the content, such as visit a physical location associated with the presented content.

### SUMMARY

An online system allows its users to create content items associated with physical locations for presentation to additional online system users and generates data describing groups of users that visit geographic areas within various distances of the physical locations associated with the content items. For example, an online system maintains a page of content items created by an owner of a retail store for presentation to online system users and generates data describing certain attributes associated with a group of users who visited a geographic area within 50 meters of the retail store within a particular time interval (e.g., within a week of a current time). Examples of content items associated with a physical location include: pages, posts to a page, status updates, photographs, videos, and any other type of content presented on the online system. A content item associated with a physical location may be a content item for which the online system receives compensation in exchange for presenting to online system users (a “sponsored content item”) or an organic content item for which the online system does not receive compensation in exchange for presenting to online system users. Examples of physical locations that may be associated with a content item include: buildings, landmarks, retail stores, and any other physical locations associated with an online system user, including physical locations where brands, products or services may be promoted or sold. Data generated by the online system describing groups of users who visited geographic areas within various distances of a physical location describes certain attributes associated with the users and the users' visits to the geographic areas (e.g., demographic attributes associated with the users, time intervals during which a maximum and a minimum number of the users visited the geographic area, etc.).

Based on the generated data describing groups of users who visited geographic areas within various distances of a physical location, the online system generates a report for a particular location and provides the report to a user associated with the physical location or to a user associated with a content item associated with the physical location. For example, the online system generates a report describing demographic attributes shared by at least a threshold amount of users of a group of users who were within 100 meters from a physical location of a retail store associated with a content item presented by the online system within a month of a current date. In the preceding example, the online system may provide the report to a client device of an owner of the store to identify certain characteristics shared by individuals who were within a threshold distance of the store (e.g., an age range occurring most frequently in the report), trends in foot traffic of users within the threshold distance of the store (e.g., busiest days and times of day), and additional users of the online system having attributes matching, or similar to, attributes of users of the group from which the report was generated to the owner.

In various embodiments, the online system determines geographic locations of online system users based on location information received from client devices associated with the users. The online system stores information received from a client device over time in association with a user associated with the client device to describe the user's geographic locations over various intervals of time. Location information received by the online system from a client device describes a geographic location of the client device and information identifying a user associated with the client device to the online system, allowing the online system to store the geographic location of the client device in association with the user identified by the location information. For example, location information describes a street address, a location identifier, geographic coordinates of geographic location of a client device, and information identifying a user associated with the client device to the online system (e.g., a user identifier of the user).

In some embodiments, a client device communicates location information to the online system when a user of the client device requests to share a physical location with the online system. Alternatively, a client device communicates location information to the online system when the client device is within at least a threshold distance from a particular physical location or at various predetermined time intervals. For example, the online system receives location information from a client device when a user checks-in to a physical location via the client device or via an application executing on the client device. As another example, the online system receives location information from a client device or from an application executing on the client device when the client device is within a threshold distance of certain devices for connecting to a network (e.g., wireless access points or cellular phone towers). In some embodiments, the online system receives location information from a client device and subsequently retrieves information identifying the user to the online system from the client device. In other embodiments, the online system receives location information from a third party system that combines a geographic location of a client device with information identifying a user of the client device to the online system. For example, the online system receives a geographic location of an online system user and information identifying the online system user from a third party system and stores the geographic location in association with the identified user. In the preceding example, the third party system may receive information indicating the user visited the physical location via a client device associated with the third party system (e.g., a point of sale terminal used by the user to complete a financial transaction at the physical location). The online system stores information describing geographic locations of its users based on the received location information and information identifying the online system users, and may update the stored information (e.g., upon receipt of updated location information) to include a historical record of a user's locations over various intervals of time, in some embodiments.

From the stored information identifying geographic locations of users, the online system identifies users who visited certain geographic areas over one or more intervals of time and generates data describing the identified users and their visits to the geographic areas. In various embodiments, the online system identifies a group of users who visited a geographic area within at least a threshold distance of a physical location associated with a content item during a specified time interval and generates data describing the identified users and their visits to the geographic area. For example, the online system retrieves the stored information describing geographic locations of its users and identifies a group of users associated with a geographic location within 150 meters of a physical location of a retail store associated with a content item during the previous week. In another example, the online system generates data describing a number of users who visited the geographic area during the previous week, during each day of the previous week, and during each hour of the previous week from the stored information.

The online system also retrieves attributes of users of the group maintained by the online system and generates data describing attributes associated with at least a threshold amount of users of the group. For example, the online system generates data describing attributes associated with at least a threshold number or at least a threshold percentage of users of the group. In other embodiments, the online system generates data describing attributes associated with each user of the group. Example attributes described by the generated data include demographic attributes (e.g., gender and age), geographic attributes (e.g., a hometown and workplace), relationship status (e.g., in a relationship, married, etc.), declared interests (e.g., hobbies), actions performed on the online system (e.g., interactions with a specific content item), and connections between the users of the group and additional users or objects on the online system. In various embodiments, the online system generates data describing a gender, an age, a hometown and/or a workplace of each user of the group. In some embodiments, the online system also generates data describing whether a user of the group has been presented with a particular content item by the online system, whether a hometown or a workplace of the user of the group is greater than (or less than) a threshold distance from a physical location associated with the particular content item, whether the user of the group interacted with the particular content item, or whether the user of the group is connected to a particular additional user or to an object via the online system.

Based on the generated data describing groups of users who visited geographic areas within various distances of a physical location, the online system generates a report describing different groups of online system users who visited a geographic area within a threshold distance of a physical location associated with a content item. In some embodiments, the online system generates a report describing multiple groups of online system users who visited geographic areas within different threshold distances of the physical location. For example, the online system generates a report describing demographic attributes associated with different groups of users who visited a geographic area within 150 meters, within 100 meters, and within 50 meters of a physical location associated with a content item within three months from a current time, within a month from the current time, and within a week from a current time.

In some embodiments, the generated report is presented to an online system user associated with the physical location or associated with a content item associated with the physical location to describe trends in foot traffic of users within one or more distances of the physical location and attributes of online system users who visited a geographic area within a threshold distance of the physical location. For example, the online system presents the report to an administrator of a page associated with a retail store and maintained by the online system to inform the administrator of times of heaviest foot traffic within a threshold distance of a physical location of the retail store and characteristics of individuals who visited a geographic area within a threshold distance of the physical location of the retail store within a particular time interval. In some embodiments, the report may include a graphical user interface for presentation by a client device associated with the user to whom the report is presented that allows the user to display various aspects and formats of the generated data by interacting with various navigational elements of the graphical user interface. For example, the administrator from the previous example selects various text boxes included a graphical user interface comprising the report to display different charts, graphs, icons, or tables describing different time intervals during which different groups of users visited geographic areas within different threshold distances of the physical location of the retail store.

In some embodiments, the online system allows the user to whom the report is presented to submit a request to the online system to present a content item associated with a physical location described in the report to additional online system users based on information included in the report. In the preceding example, the administrator may submit a request to the online system to present a content item associated with the retail store to additional users of the online system having at least a threshold number or a threshold percentage of attributes matching attributes of a group described in the report (e.g., users having at least a threshold number of attributes matching attributes of users of a group of users who were within 50 meters of the store during a time interval in which a maximum number of users were in the geographic area). Using information included in the report to identify additional users allows the administrator of the preceding example to target delivery of the content item to users most likely to perform one or more actions after being presented with the content item.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for determining attributes of online system users within a threshold distance of a physical location during a specified time interval, in accordance with an embodiment.

FIG. 4 is an example report generated by the online system describing users who checked-in to a business at a physical location during a time interval, in accordance with an embodiment.

FIG. 5 is an example report generated by the online system describing ages of users who were within a threshold distance of a physical location during a time interval, in accordance with an embodiment.

FIG. 6 is an example report generated by the online system describing genders of users who were within a threshold distance of a physical location during a time interval, in accordance with an embodiment.

FIG. 7 is an example report generated by the online system describing home locations of users who were within a threshold distance of a physical location during a time interval, in accordance with an embodiment.

FIG. 8 is an example report generated by the online system describing presentation of a content item to users who were within a threshold distance of a physical location during a time interval, in accordance with an embodiment.

FIG. 9 is an example report generated by the online system describing ages and genders of users who were within a threshold distance of a physical location during a time interval, in accordance with an embodiment.

FIG. 10 is an example report generated by the online system describing visits at different times of day by users to a geographic area within a threshold distance of a physical location during a time interval, in accordance with an embodiment.

FIG. 11 is an example report generated by the online system describing visits during different weeks by users to a geographic area within a threshold distance of a physical location during a time interval, in accordance with an embodiment.

FIG. 12A is an example report generated by the online system describing trends in visits by users of different ages to a geographic area within a threshold distance of a physical location during a time interval, in accordance with an embodiment.

FIG. 12B is an example report generated by the online system describing trends in visits by users of different genders to a geographic area within a threshold distance of a physical location during a time interval, in accordance with an embodiment.

FIG. 12C is an example report generated by the online system describing trends in visits by users from different home locations to a geographic area within a threshold distance of a physical location during a time interval, in accordance with an embodiment.

FIGS. 13A and 13B are example reports generated by the online system describing performance of content presented by the online system, in accordance with an embodiment.

FIG. 14 is an example report including a graphical user interface generated by the online system describing visits by users to a geographic area within a threshold distance of a physical location during a time interval, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

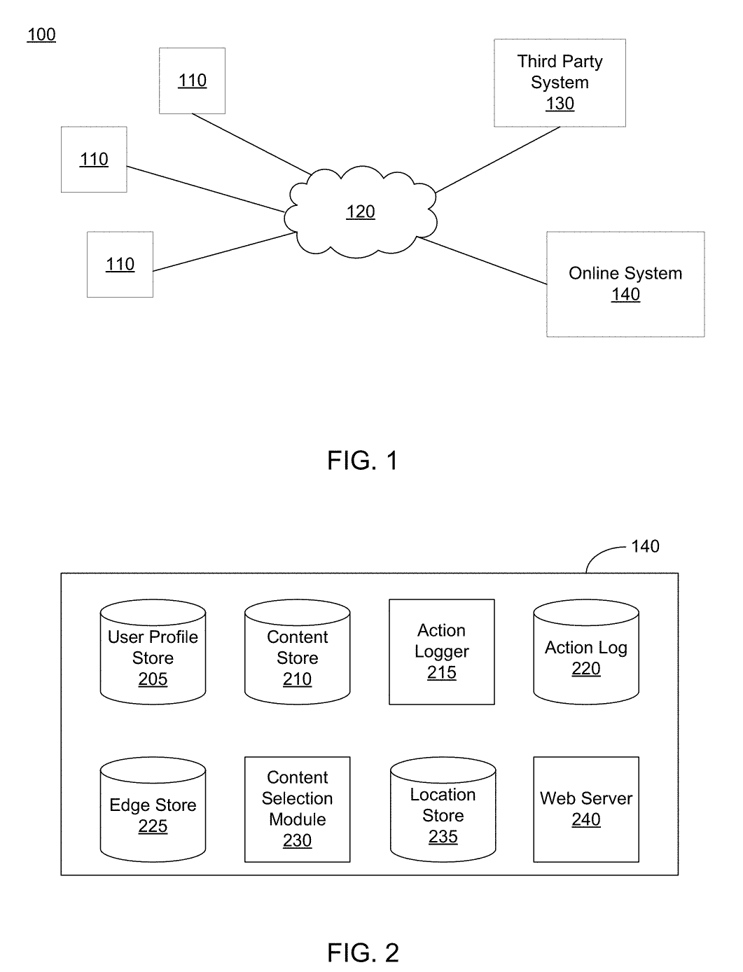

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The online system 140 may be a social networking system, a content sharing network, or another systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

In some embodiments, one or more of the third party systems 130 provide content to the online system 140 for presentation to users of the online system 140 and provide compensation to the online system 140 in exchange for presenting the content. For example, a third party system 130 provides content items to the online system 140 for presentation to online system users and amounts of compensation provided by the third party system 130 to the online system 140 in exchange presenting content items to the online system users. Content for which the online system 140 receives compensation in exchange for presenting is referred to herein as “sponsored content.” Sponsored content from a third party system 130 may be associated with the third party system 130 or with another entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, a content selection module 230, a location store 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity. In some embodiments, the brand page associated with the entity's user profile may retrieve information from one or more user profiles associated with users who have interacted with the brand page or with other content associated with the entity, allowing the brand page to include information personalized to a user when presented to the user.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications, such as third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), engaging in a transaction, viewing an object (e.g., a content item), and sharing an object (e.g., a content item) with another user. Additionally, the action log 220 may record a user's interactions with content items on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, content that was engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features that each represent characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or a particular user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Se.r No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Information associated with the user included in the user profile store 205, in the action log 220, and in the edge store 225 may be used to determine the measures of relevance. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having a highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content (also referred to as a “content feed”) to a user of the online system 140. The feed may include one or more content items associated with bid amounts (i.e., “sponsored content items”) as well as organic content items, such as stories describing actions associated with other online system users connected to the user. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a feed including a plurality of content items selected for presentation to the user. One or more content items associated with bid amounts may be included in the feed. The content selection module 230 may also determine an order in which selected content items are presented via the feed. For example, the content selection module 230 orders content items in the feed based on likelihoods of the user interacting with various content items.

The location store 235 stores location information received from client devices 110 associated with online system users. Location information received from a client device 110 identifies a geographic location of the client device 110 and information identifying a user of the client device 110 to the online system 140 user identifying information identifying online system users associated with the client devices 110. Location information may include any information suitable for identifying a geographic location of a client device 110 associated with an online to the online system. For example, location information includes information identifying a street address, a location identifier, or geographic coordinates of a geographic location of a client device 110 in association with information identifying a user associated with the client device 110 to the online system 140 (e.g., a user identifier of the user). The online system 140 retrieves a user profile or other information associated with the user identified from the information identifying the user in the location information and stores the geographic location of the client device 110 identified by the location information in associated with the identified user in the location store 235. In some embodiments, the online system 140 receives location information along with information identifying an online system user from a client device 110 associated with the online system user. Alternatively, the online system 140 receives location information from a client device 110 associated with an online system user and subsequently retrieves information identifying the user from the client device 110. In various embodiments, location information received by the online system 140 describing a geographic location of a client device 110, a time associated with the geographic location, and information identifying a user associated with the client device 110, allowing the online system to store the time associated with the geographic location in the location store 235 in association with the geographic location and information identifying the user associated with the client device 110.

Location information may be communicated to the online system 140 by a client device 110 or by an application executing on the client device 110 when a user of the client device 110 requests to share a location with the online system 140. For example, the online system 140 receives location information from a client device 110 when a user of the client device 110 requests to share a location with the online system 140 by checking-in to a physical location (e.g., a restaurant, a retail store, a park etc.) via the client device 110 or via an application executing on the client device 110. Location information may also be communicated to the online system 140 by a client device 110 or by an application executing on the client device 110 when the client device 110 is within a threshold distance of a specified physical location or device, at periodic time intervals, or when any other suitable condition is satisfied. For example, the online system 140 receives location information from a client device 110 or from an application executing on the client device 110 when the client device 110 is within a threshold distance of certain devices for connecting to a network 120 (e.g., wireless access points or cellular phone towers). As another example, the online system 140 receives location information from a client device 110 or from an application executing on the client device 110 when a location of the client device 110 changes, allowing the online system 140 to maintain information describing a current location of the client device 110.

In some embodiments, the online system 140 receives location information from a third party system 130 that combines a geographic location of a client device 110 with information identifying a user of the client device 110 to the online system 140. For example, the online system 140 receives a geographic location of a user of the online system 140 and information identifying the user of the online system 140 from a third party system 130 and stores the geographic location in association with the identified user in the location store 235. In the preceding example, the third party system 130 may receive information indicating the user visited the geographic location via a client device 110 associated with the third party system 130. For example, the third party system 130 identifies the online system user based on information provided to the third party system 130 by the user at a point of sale terminal used by the user to engage in a financial transaction at the geographic location.

In some embodiments, the online system 140 updates stored location information as updated location information is received to maintain a historical record of a user's locations over various time intervals. If the online system 140 updates stored location information, the online system 140 may maintain previously stored location information when the updated location information is stored or may alternatively remove previously stored location information and store the updated location information in its place, in various embodiments. For example, the online system 140 receives updated location information in response to a change in the location of a client device 110 associated with an online system user and stores the updated location information in the location store 235 along with location information previously received from the client device 110 within a particular time interval.

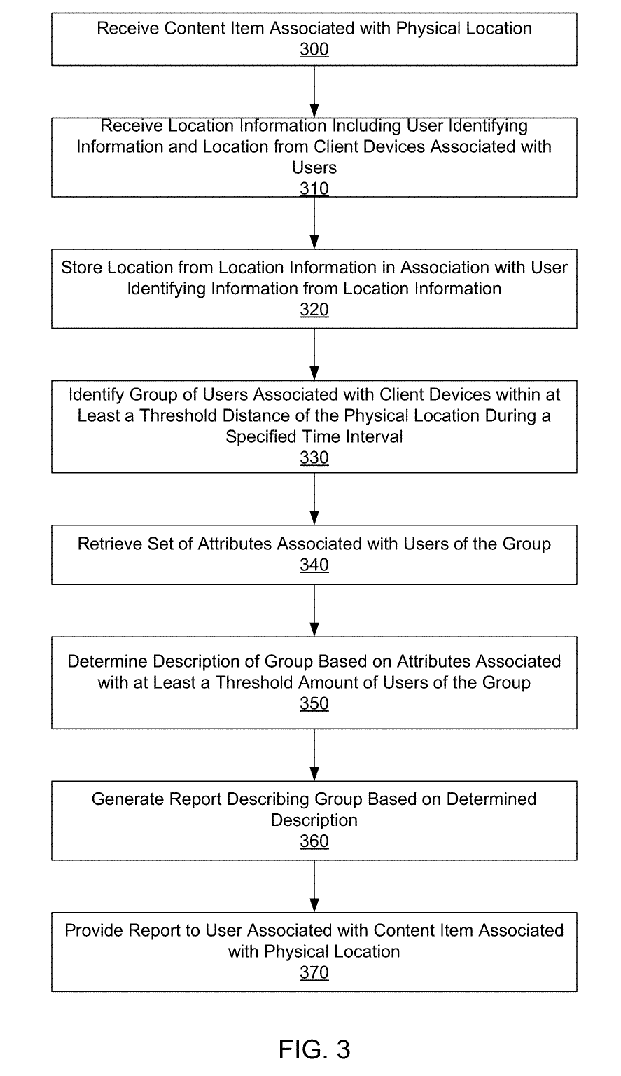

In some embodiments, location information identifies a geographic location associated with a content item presented by the online system 140 or associated with a publishing user who provided the content item (e.g., a sponsored content item) to the online system 140 for presentation by the online system 140. Additionally, location information may identify occurrence of an action associated with the content item or user who provided the content item to the online system 140. For example, location information identifies physical locations of retail stores, buildings, or other locations where a user has performed a particular action (e.g., a purchase or transaction) associated with a content item presented by the online system 140 or a user associated with the content item. In various embodiments, a publishing user who provides content to the online system 140 or a user associated with the content identifies an action and a physical location associated with the action, and location information received by the online system 140 identifies the action and users that performed the action within a threshold distance of the physical location. In some embodiments, location information stored in the location store 235 also includes various attributes of the locations. Example attributes of a location include: types of connections to a network 120 (e.g., BLUETOOTH®, 802.11, global positioning system, etc.) available from a location, identifiers of wireless access points within a threshold distance of the location, identifiers of cellular phone towers within a threshold distance of the location, or other suitable information. For example, location information describing an action occurring at a physical location associated with a content item presented by the online system 140 includes a type of connection to a network 120 available at the physical location. As further described below in conjunction with FIGS. 3-14, the online system 140 may analyze location information included in the location store 235 and other information included in the user profile store 205, in the action log 220, and in the edge store 225 to determine attributes of users within a threshold distance of a physical location.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, or BlackberryOS.

### Determining Attributes of Online System Users Within a Threshold Distance of a Physical Location During a Specified Time Interval

FIG. 3 is a flowchart of one embodiment of a method for determining attributes of online system users within a threshold distance of a physical location during a specified time interval. In other embodiments, the method may include different and/or additional steps than those shown in FIG. 3. Additionally, steps of the method may be performed in different orders than the order described in conjunction with FIG. 3 in various embodiments.

The online system 140 receives 300 a content item associated with a physical location from an online system user for presentation to additional online system users. In various embodiments, the online system 140 receives 300 a content item associated with a particular physical location and including targeting criteria specifying characteristics of users eligible to be presented with the content item, as further described above in conjunction with FIG. 2. For example, the online system 140 receives 300 a content item associated with a business associated with the user from whom the request was received 300. The content item is associated with a street address of a physical location of the business and one or more targeting criteria specifying attributes of additional users to whom the content item is eligible to be presented. As described above in conjunction with FIG. 2, the content item is eligible for presentation to additional users having attributes satisfying at least a threshold amount of the targeting criteria.

Content items that may be associated with a physical location include pages, page posts, status updates, photographs, videos, and any other type of content presented on the online system 140. Content items associated with a physical location may be sponsored content items for which the online system 140 receives compensation in exchange for presenting to online system users or may be organic content items for which the online system 140 does not receive compensation in exchange for presenting to online system users. Physical locations that may be associated with a content item include buildings, landmarks, retail stores, and any other physical locations associated with an online system user from whom the content item was received 300, associated with a product or a service identified by the content item, or otherwise associated with the content item (including physical locations where brands, products or services associated with the content item may be promoted or sold).

In various embodiments, the online system 140 stores the received content item in association with information describing the physical location associated with the content item and targeting criteria associated with the content item for subsequent retrieval. For example, the online system 140 retrieves the content item and associated targeting criteria from the content store 210, identifies an online system user having attributes satisfying at least a threshold amount of the targeting criteria, and provides the content item to a client device 110 associated with the identified user for presentation.

The online system 140 also receives 310 location information and user identifying information from client devices 110 associated with a plurality of users of the online system 140. As further described above in conjunction with FIG. 2, location information identifies a geographic location of a client device 110 associated with an online system user and includes information identifying the online system user to the online system 140. For example, the online system 140 associates the geographic location of the client device 110 from the location information with the online system user identified by the location information to determine a physical location of the online system user. For example, location information includes a street address, a location identifier and/or geographic coordinates of a geographic location of a client device 110 and information identifying a user associated with the client device 110 to the online system 140 (e.g., a user identifier of the user).

In various embodiments, location information received 310 from a client device 110 describes a geographic location of the client device 110, a time associated with the geographic location (e.g., a time when the client device 110 was at the location), and information identifying an online system user associated with the client device 110, allowing the online system 140 to associate the geographic location and the time with the online system user. For example, the online system 140 receives 310 location information from a client device 110 of an online system user describing a particular street address, a time when the client device 110 was within at least a threshold distance of the particular street address, and a device identifier associated with the client device 110. In this example, the online system 140 matches the received device identifier with a device identifier stored in a user profile associated with a user of the online system 140, identifies the user associated with the user profile including the device identifier, and associates the particular street address and the time described by the location information with the identified user.

In various embodiments, location information is received 310 from a client device 110 when a user of the client device 110 requests to share a location with the online system 140, when the client device 110 is within at least a threshold distance of a particular location, at various predetermined time intervals, or when any other suitable condition is satisfied. For example, the online system 140 receives 310 location information from a client device 110 when the client device 110 is within a threshold distance of the physical location associated with the content item received 300 by the online system 140. In some embodiments, location information received 310 from a client device 110 includes user identifying information allowing the online system 140 to identify a user associated with the client device 110 from the received location information. However, in other embodiments, the online system 140 retrieves user identifying information from a client device 110 in response to receiving 310 location information from the client device 110. For example, the online system 140 retrieves a device identifier from a client device 110 from which location information was received 310 and matches the device identifier to a device identifier stored in association with a user profile of an online system user to identify the user associated with the client device 110. As another example, the online system 140 retrieves a user identifier associated with a user profile maintained by the online system 140 from a client device 110 from which location information was received 310, or from an application associated with the online system 140 executing on the client device 110 from which location information was received 310, and associates the geographic location included in the location information with a user profile associated with the retrieved user identifier.

In other embodiments, the online system 140 receives 310 location information from a third party system 130 that combines a geographic location of a client device 110 with information identifying a user of the client device 110 to the online system 140. For example, the online system 140 receives 310 location information from a third party system 130 identifying a physical location associated with the third party system 130 along with information identifying an online system user who visited the physical location. The physical location associated with the third party system 130 and information identifying the online system user are combined to form location information that is communicated to the online system 140 by a device associated with the third party system 130, such as a point of sale terminal used by the user to engage in a financial transaction at a physical location, or may be obtained from the device by the third party system 130, which communicates the location information to the online system 140.

In various embodiments, location information identifies a geographic location associated with a content item presented by the online system 140 or associated with a user from whom the content item was received 300. For example, the online system 140 receives 310 location information identifying physical locations of retail stores, buildings, or other locations where a user has performed an action (e.g., a purchase or transaction) associated with a content item presented by the online system 140, along with information identifying the user and the action performed by the user. For example, the location information identifies a physical location associated with a content item maintained by the online system 140 when a location of a client device 110 is within a threshold distance of the physical location, as well as information identifying the user. As another example, the location information identifies a physical location associated with a content item maintained by the online system 140 when the client device 110 obtains information indicating the user performed a particular action within a threshold distance of the physical location, as well as information identifying the user and the particular action

The online system 140 stores 320 the received location information in association with a user corresponding to user identifying information included in the location information or otherwise associated with the location information, allowing the online system 140 to associate geographic locations described by the location information with users identified by user identifying information corresponding to the location information. For example, the online system 140 stores 320 information describing a street address and a time of visit associated with the street address received 310 from a user's mobile phone along with an identifier of the user for later retrieval. In this example, the online system 140 retrieves the stored information and determines the online system user visited a physical location at the described street address during the stored time of visit. In various embodiments, the online system 140 updates the stored information to maintain a historical record of a user's locations over various time intervals. For example, the online system 140 updates location information stored 320 in the location store 235 in association with an identifier of an online system user in response to receiving 310 updated location information at a time subsequent to a time when location information was previously stored 320 for the user, allowing the online system 140 to maintain a historical record of physical locations associated with the user over a period of time. Hence, maintains a historical record of physical locations associated with users over time based on received location information identifying the user.

Based at least in part on the stored information describing physical locations associated with users at various times, the online system 140 identifies 330 a group of users who were within at least a threshold distance of the physical location associated with the content item received 300 by the online system 140 during a specified time interval. In various embodiments, the threshold distance and time interval may be specified by the online system 140. Alternatively, a user of the online system 140, such as a user associated with the content item or a user associated with the physical location associated with the content item, specifies the threshold distance and time interval. In some embodiments, the online system 140 identifies 330 a group of users who were within at least a threshold distance of the physical location during a specified time interval in response to receiving a request from a user associated with a content item associated with the physical location for information describing users within a specified distance of the physical location during the time interval. For example, if a publishing user who provided a content item associated with a restaurant to the online system 140 for presentation requests a report describing characteristics of online system users who were within 100 yards of the restaurant during a previous week, the online system 140 identifies 330 a group of users who were within 100 yards of the restaurant during the previous week based on the information describing various physical locations of online system users stored 320 by the online system 140.

To identify 330 the group of users, the online system 140 identifies 330 users associated with stored location information describing geographic locations of client devices 110 that were within at least the threshold distance of the physical location during the specified time interval based on geographic locations stored 320 from received location information. For example, the online system 140 retrieves geographic locations within the threshold distance of the physical location during the specified time interval previously stored 320 in association with various users based on location information received 310 by the online system 140. In some embodiments, the online system140 selects users associated with geographic locations within the threshold distance of the physical location and identifies 330 users of the selected users associated with a geographic location within the threshold distance of the physical location during the specified time interval.

The online system 140 retrieves 340 a set of attributes maintained by the online system 140 in association with each user of the identified group and determines 350 a description of the group of users based at least in part on attributes associated with at least a threshold amount of users of the group. In various embodiments, the online system retrieves 340 one or more attributes associated with at least a threshold number or a threshold percentage of users of the group and determines 350 a description of the group describing the retrieved one or more attributes. For example, the online system 140 retrieves 340 an attribute associated with at least a threshold number or a threshold percentage of users of the identified group, generates data describing a value or a characteristic of the attribute, and determines 350 a description of the group identifying the value or the characteristic of the attribute. In other embodiments, the online system 140 determines 350 the description of the group as a description of one or more attributes associated with every user of the group.

In various embodiments, a value of an attribute described by the generated description of the group data includes an amount (e.g., a number or a percentage) of users who are associated with the attribute or with a characteristic of an attribute. For example, an attribute describing an interest of a user has a value of “sports,” and an attribute describing a relationship of a user has a value of “in a relationship.” As another example, an attribute describing a hometown of a user has a value of “Santa Ana, Calif.” and an attribute describing a presentation of a content item to a user has a value of a content item identifier identifying a particular content item that was presented to the user.

Attributes that the online system 140 maintains in association with users of the identified group include: demographic attributes (e.g., a gender of a user, an age of a user), geographic attributes (e.g., a hometown of a user, a workplace of a user), and relationship attributes (e.g., a marital status of a user). For example, if the online system 140 maintains demographic information (e.g., in user profiles maintained by the online system 140) for at least a threshold number or a threshold percentage of users of the group, the online system retrieves 340 the demographic information and determines 350 a description of the report identifying a number or a percentage of users of the group having a particular age and gender based on the demographic information. As another example, the online system 140 determines 350 a description of the group that indicates the group includes male and female online system users having particular ages within the threshold distance of the physical location during the specified time interval. In another example, if each of a threshold number or a threshold percentage of users of the group provided the online system 140 with information describing a hometown or a workplace of the user, the online system 140 retrieves 340 the information and determines 350 a description of the group describing a number or percentage of users of the group who are from a particular hometown or who work in a particular city. In this example, the online system 140 may also determine 350 a description of the group that includes a number or a percentage of users who have a hometown or workplace that is greater than or is less than a specified distance from the physical location.

Additionally, the description of the group determined 350 by the online system 140 may identify declared interests or hobbies of the users. For example, the online system 140 retrieves 340 a set of attributes associated with at least a threshold amount of users of the group to determine declared interests and hobbies of the users, and determines 350 a description of the group identifying a particular percentage of users who play sports and an additional percentage of users who are car enthusiasts. The online system 140 may also retrieve 340 attributes maintained by the online system 140 in association with users of the group describing presentation of content items to the users of the group and interactions with the content items by the users of the group. For example, an attribute associated with each of a threshold amount of users of the group identifies a content item presented to the users by the online system 140 and a time when the content item was presented to the users. In this example, the online system 140 determines 350 a description of the group identifying a number of users of the group who were presented with the content item and an additional number of users of the group who were not presented with the content item. As another example, an attribute describes interactions of users with the content item received 300 by the online system 140 and associated with the physical location and interactions of users with an additional content item not associated with the physical location. For example, the online system 140 determines 350 a description of the group including a number (or a percentage) of users of the group who interacted with the content item during the specified time interval and including a number (or a percentage) of users of the group who interacted with the additional content item (e.g., by selecting a link included in the additional content item) during the specified time interval.

The online system 140 may determine 350 the description of the group so the description identifies certain actions performed by users of the group on the online system 140 or connections between users of the group and additional users or objects on the online system 140. For example, attributes associated with users of the group by the online system 140 identify businesses or other locations to which a user has checked-in via an application associated with the online system 140 executing on a client device 110 associated with the user and a time when each check-in was performed the user performed each check-in, and the online system 140 determines 350 a description of the group identifying businesses or other locations to which at least a threshold number or a threshold percentage of users of the group checked-in. As another example, the online system 140 retrieves 340 attributes describing connections between users of the group and a page maintained by the online system 140 and determines 350 a description of the group including a number or a percentage of users of the group who are connected to the page and who have visited the page at least a threshold number of times during the specified time interval.

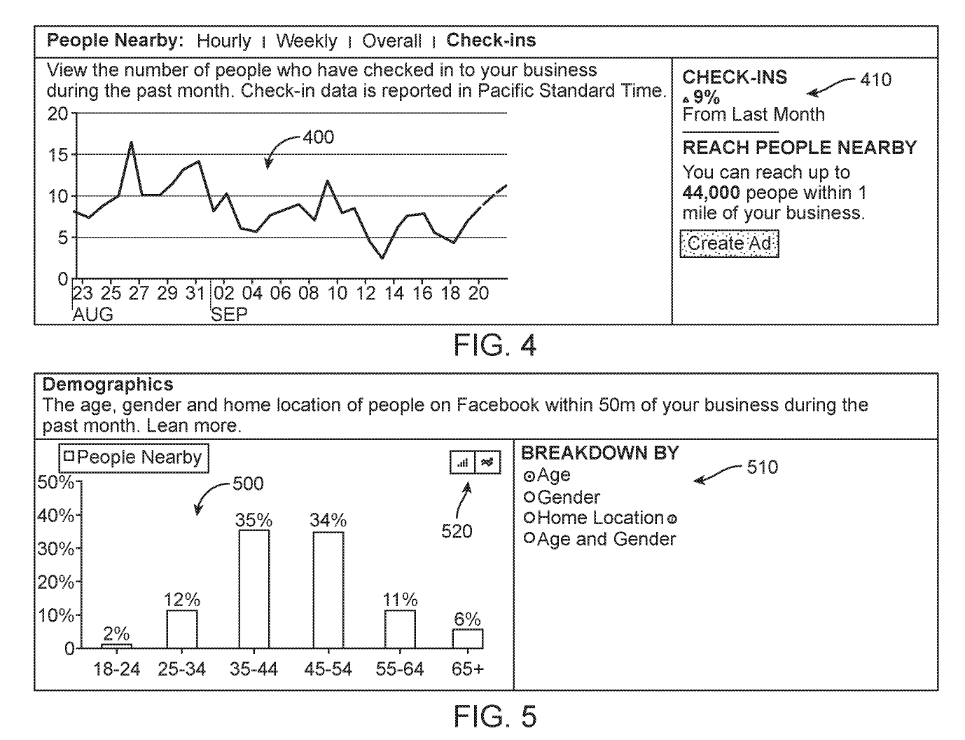

Based on the determined description of the group of users, the online system 140 generates 360 a report describing the group of users. For example, as illustrated in FIG. 4, if the online system 140 determines 350 a description of the group as including users who checked-in to a business at the physical location associated with the content item during a one-month time interval, the online system 140 generates 360 a report describing a number 400 of users of the group who checked-in to the physical location during each day of the one-month time interval. The report may also describe a difference 410 between the amount of users who checked-in to the physical location during the one-month time interval and an amount of users who checked-in to the physical location during a previous time interval, as shown in the example of FIG. 4, allowing the report to identify changes in the amount of users who check-in to the physical location over time.

In various embodiments, the online system generates 360 a report describing the group of users based at least in part on one or more values or characteristics of at least one attribute on which the description of the group was based. In certain embodiments, the one or more values or characteristics of an attribute include an amount (e.g., a number or a percentage) of users who are associated with a particular attribute or a particular characteristic of an attribute. For example, an attribute describing a presentation of a content item to a user has a value indicating a number of times the content item was presented to the user, and another attribute identifying a workplace of a user has a characteristic of “San Francisco, Calif.” As another example, an attribute describing a user's gender has a characteristic of “male” or “female.” Similarly, an attribute describing an age of a user has a characteristic such as “23 years” or “over the age of 18.”

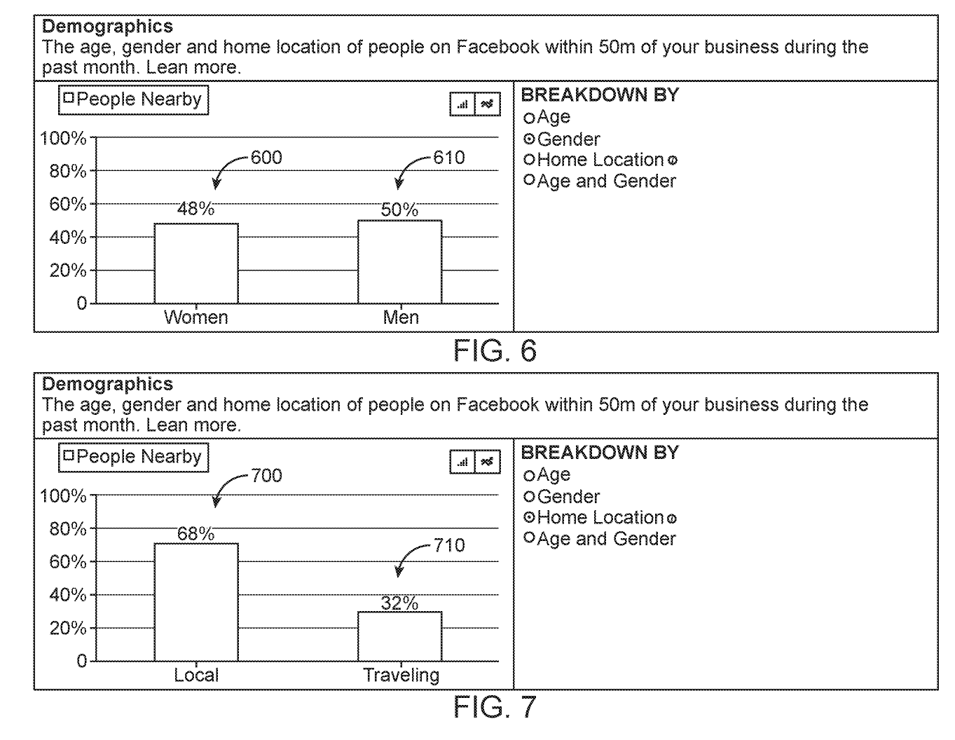

In the example of FIG. 5, the online system 140 determines 350 a description of the group of users identifying the group as including users over the age of 18 who were within at least 50 meters of a physical location of a particular business during a past month and generates 360 a report identifying a percentages 500 of users of the group who are ages 18 to 24, ages 25 to 34, ages 35 to 44, ages 45 to 54, ages 55 to 64, and age 65 and over. Similarly, in the example of FIG. 6, the online system 140 determines 350 the group of users includes male and female users who were within at least 50 meters of the physical location during a prior month based on characteristics of a gender attribute associated with at least a threshold amount of users of the group, so the online system 140 generates 360 a report identifying a percentage 600 of users of the group who are women and a percentage 610 of users of the group who are men. As another example, shown in FIG. 7, the description of the group of users identifies a geographic attribute associated with at least the threshold amount of users of the group indicating a hometown of the users, so the online system 140 generates 360 a report identifying a percentage 700 of users of the group who are from a hometown that is less than a threshold distance from the physical location and a percentage 710 of users of the group who are from a hometown that is at least the threshold distance from the physical location.

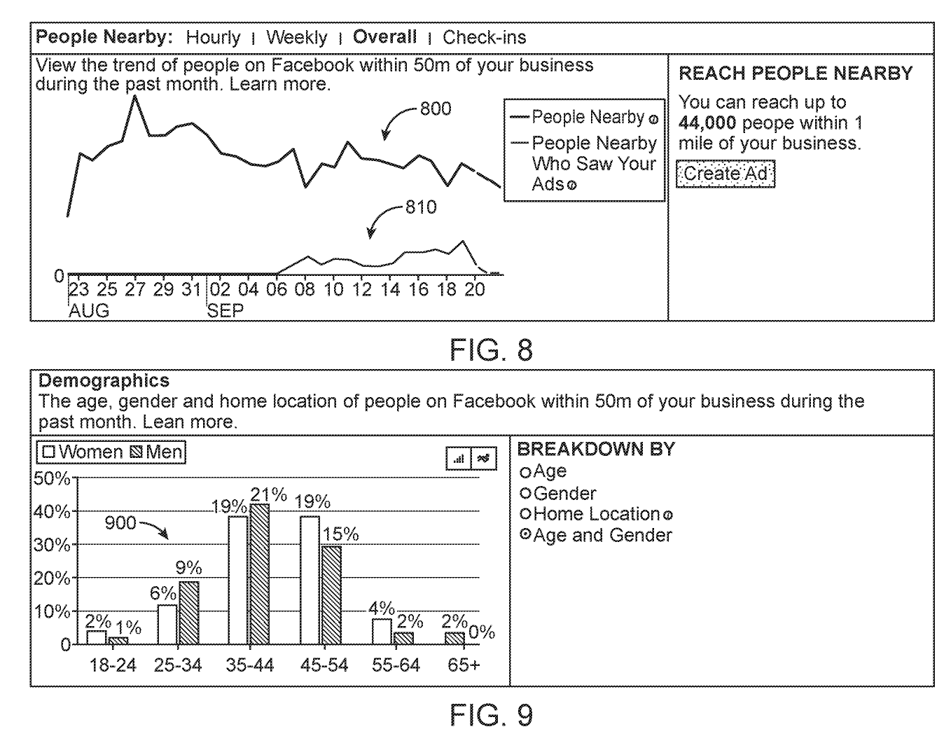

In various embodiments, the generated report describes the group of users based at least in part on values or characteristics of one or more attributes associated with various subgroups of the group of users. FIG. 8 shows an example report where the online system determines 350 the group of users includes at least a threshold amount of users who were presented with the content item received 300 by the online system 140 and associated with the physical location within a month prior to a current time, the online system 140 generates 360 a report describing an amount 800 of users of the group who were within the geographic area within the threshold distance of the physical location during each day of the month prior to the current time and an amount 810 of users in a subgroup of the group of users who were presented with the content item associated with the physical location during each day of the month prior to the current month. As an additional example shown in FIG. 9, if the online system 140 determines 350 the description of the group identifies male and female users over the age of 18 who were within at least 50 meters of the physical location within a month prior to a current time and generates 360 a report identifying a percentage 900 of users who are in different male and female subgroups of the group of users. For example, the report identifies percentages of male users in the group who are ages 8 to 24, ages 25 to 34, ages 35 to 44, ages 45 to 54, ages 55 to 64, and age 65 and over. Similarly, the report identifies percentages of female users in the group who are ages 8 to 24, ages 25 to 34, ages 35 to 44, ages 45 to 54, ages 55 to 64, and age 65 and over. In other embodiments, the generated report describes multiple groups of online system users who visited geographic areas within different threshold distances of the physical location during different time intervals. For example, the online system generates 360 a report describing demographic attributes associated with different identified groups of users who visited a geographic area within 150 meters, within 100 meters, and within 50 meters of the physical location within three months from a current time, within a month from the current time, and within a week from the current time.

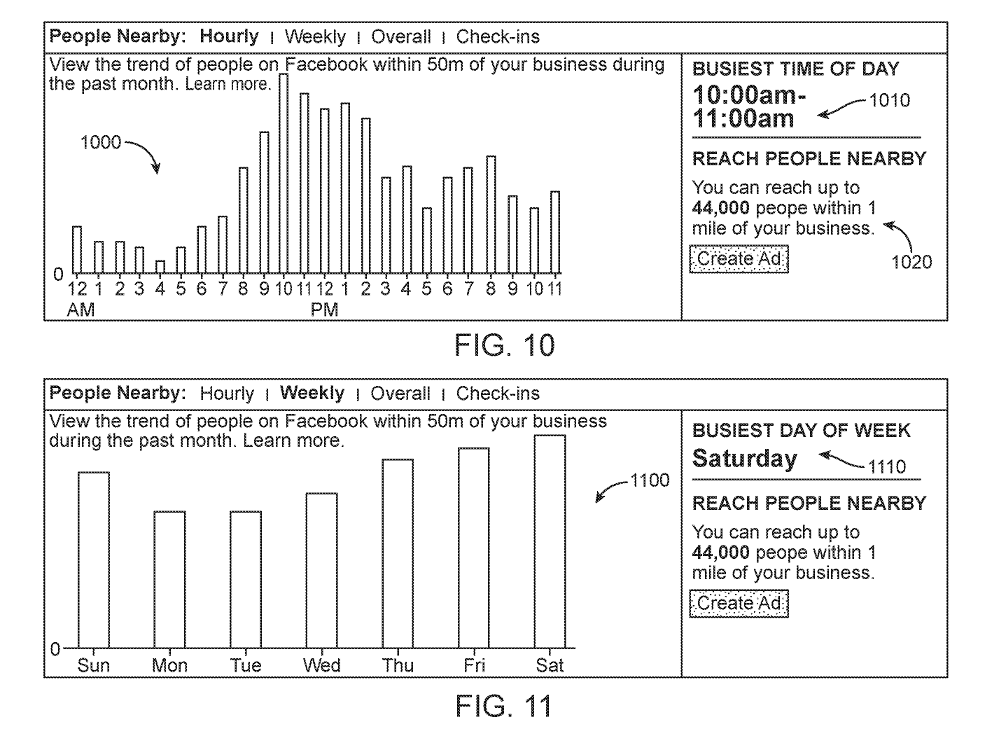

The generated report may also describe the group of users based at least in part on various characteristics of visits by users of the group to a geographic area within the threshold distance of the physical location during the specified time interval. For example, the online system 140 generates 360 a report describing a time or different times at which one or more individual users of the group visited the geographic area, including a number of users of the group who visited the geographic area during the time or during each of the different times and a number of visits by users of the group to the geographic area during the time or during each of the different times. As illustrated in the example of FIG. 10, the online system 140 generates 360 a report that describes an hourly amount 1000 of users of the group who visited a geographic area within 50 meters of the physical location during each hour of a particular day and a time 1010 of the day during which a maximum amount of users of the group visited the geographic area. As an additional example, shown in FIG. 11, the online system 140 generates 360 a report describing a weekly amount 1100 of users of the group who visited a geographic area within 50 meters of the physical location during each day of a particular week and a day 1110 of the week during which a maximum amount of users of the group visited the geographic area. Hence, the generated report may include a time during which a maximum or a minimum amount of users of the group were within at least the threshold distance of the physical location during the specified time interval and a maximum or a minimum amount of visits made by the users to a geographic area within the threshold distance of the physical location.

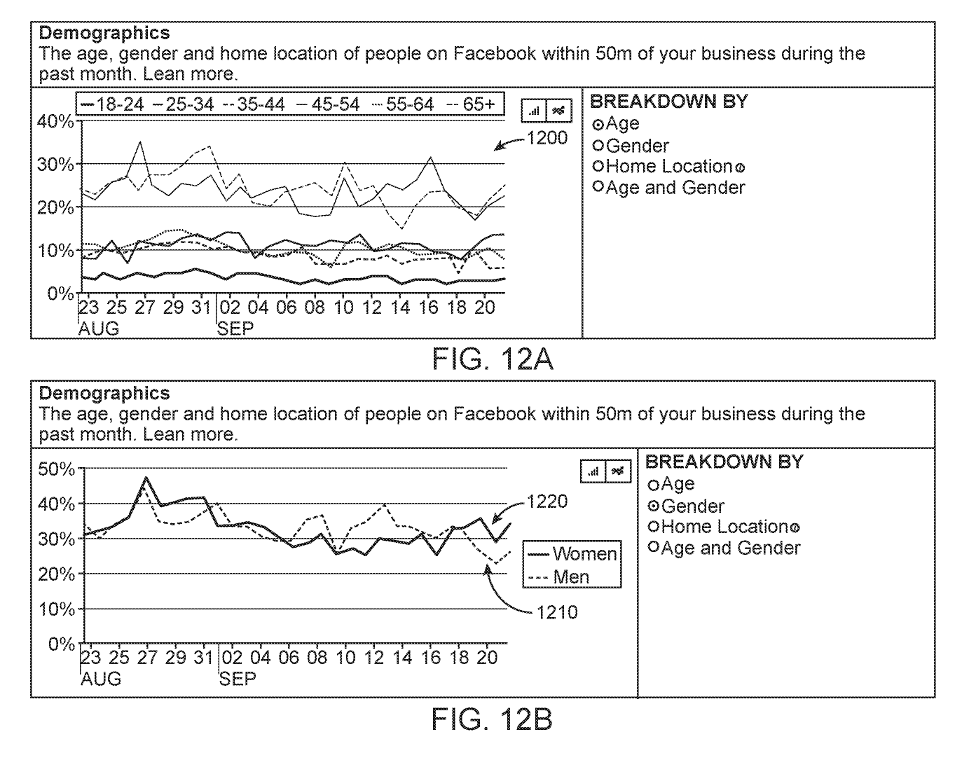

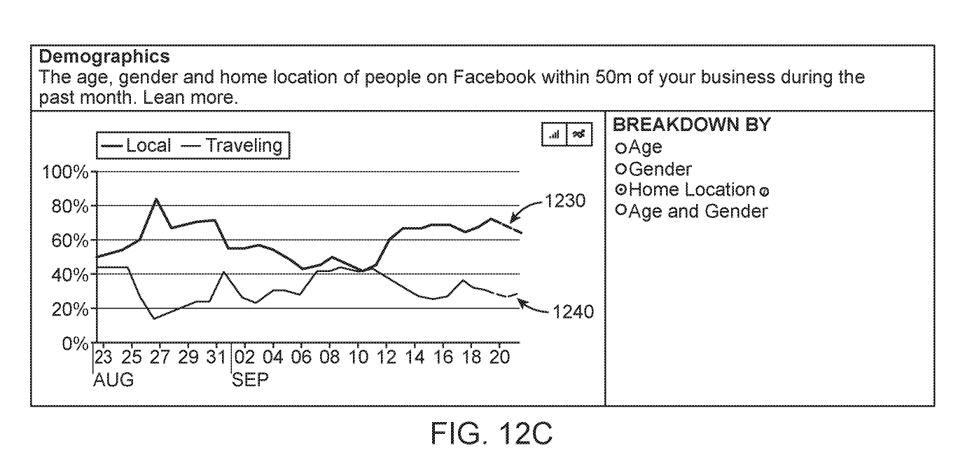

The report generated 360 by the online system 140 may also describe changes in visits to a geographic area within the threshold distance of the physical location during the time interval by the group or by various subgroups of the group based on different characteristics of the visits or attributes on which the description of the group was based, in some embodiments. To describe changes in visits by the group or by various subgroups of the group to the geographic area within the threshold distance of the physical location during the time interval, the generated report may include various text boxes, charts, graphs, icons, and tables. For example, referring back to FIG. 5, the online system generates 360 a report including a bar graph identifying a percentage 500 of users in each of six different age subgroups of the group who were within the threshold distance of the physical location during a one-month time interval, describing the group of users based on an attribute identifying an age of each user of the group. To identify changes in visits by users of different age groups during the one-month time interval, the generated report also includes a line graph, as illustrated in FIG. 12A, describing a percentage 1200 of users in each of the six different age subgroups of the group who visited within the threshold distance of the physical location during each day of the one-month time interval. As another example, the online system 140 generates 360 the report illustrated in FIG. 6 including a bar graph identifying a percentage 600 of female users of the group who were within the threshold distance of the physical location during a one-month time interval and a percentage 610 of male users of the group who were within the threshold distance of the physical location during the one-month time interval based on an attribute identifying gender of users of the group. To describe changes in visits to the geographic area within the threshold distance of the physical location based on the same attribute during the one-month time interval, the generated report also includes a line graph, shown in FIG. 12B, which describes a percentage 1210 of male users of the group who were within the threshold distance of the physical location during each day of the one-month time interval and a percentage 1220 of female users of the group who were within the threshold distance of the physical location during each day of the one-month time interval. In another example, referring back to FIG. 7, the online system 140 generates 360 a report including a bar graph identifying a percentage 700 of users of the group who are associated with an attribute specifying a hometown that is less than a threshold distance from the physical location (“local users”) and a percentage 710 of users of the group who are associated with an attribute describing a hometown that is at least the threshold distance from the physical location (“traveling users”). To describe changes in visits to the geographic area surrounding the physical location based on the same attribute, the generated report also includes a line graph, illustrated in FIG. 12C, describing a percentage 1230 of local users who were within the threshold distance of the physical location during each day of the one-month time interval and a percentage 1240 of traveling users who were within the threshold distance of the physical location during each day of the one-month time interval.

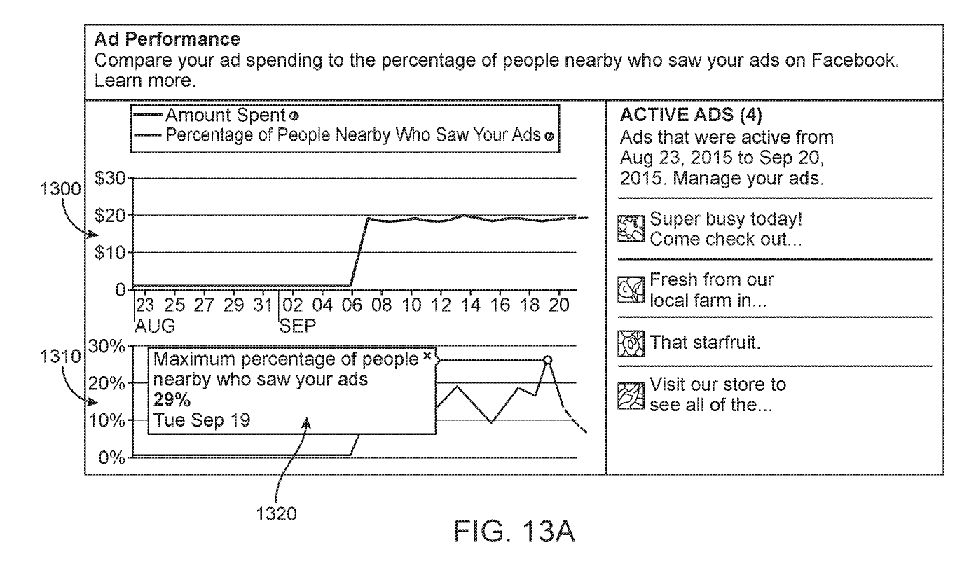

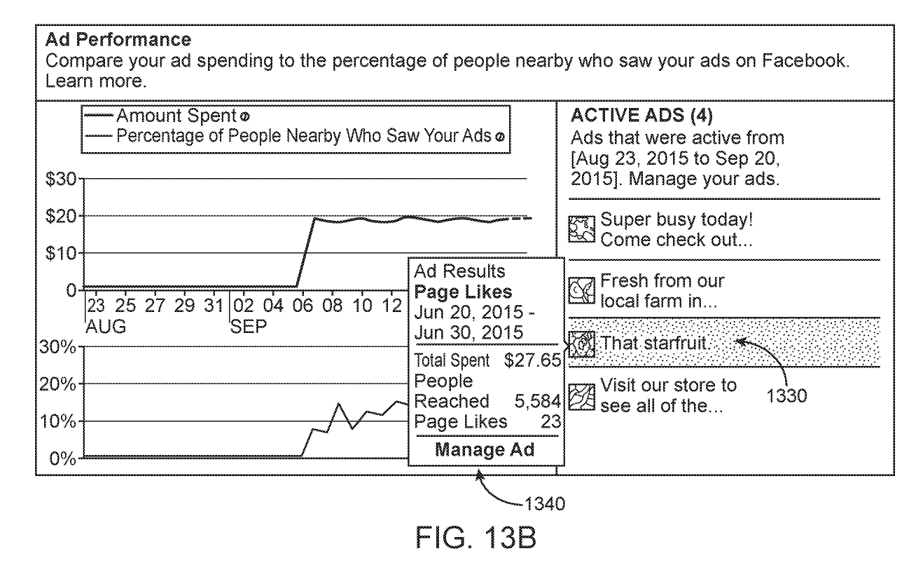

In some embodiments, the generated report may also describe the group of users based on performance of various content items presented by the online system 140 to users of the group. For example, as shown in FIG. 13A, the online system 140 generates 360 a report describing an amount 1300 of monetary compensation received by the online system 140 in exchange for presenting the content item associated with the physical location to online system users during each day (or during any suitable portion) of the specified time interval and an amount 1310 of users of the group associated with an attribute indicating presentation of the content item to a user and a time within the specified time interval the content item was presented to a user. In the example of FIG. 13A, the report also includes information 1320 identifying a maximum amount of users of the group who were presented with the content item on a single day during the specified time interval and a day of the specified time interval during which a maximum amount of users of the group were presented with the content item. The generated report may include additional information describing performance of the one or more content items associated with the physical location. As shown in the example of FIG. 13B, the report identifies content items 1330 associated with the physical location or associated with the user associated with the physical location presented by the online system 140 during the specified time interval, and information 1340 describing an amount of the compensation received by the online system 140 in exchange for presenting a specific content item associated with the physical location, a number (or a percentage) of online system users who were presented with the content item during the specified time interval, and a number of interactions (e.g., a number of a specific interaction) performed by online system users with the content item. Hence, the online system 140 generates 360 a report describing various attributes associated with at least a threshold amount of users of a group of online system users who were associated with a geographic location within at least the threshold distance of the physical location during the specified time interval. The report may also describe changes in numbers of users associated with one or more geographic locations within the threshold distance of the physical location during the specified time interval or changes in frequencies with which users are associated with geographic locations within the threshold distance of the physical location.

Returning to FIG. 3, the online system 140 provides 370 the report to an online system user associated with the physical location or associated with the content item associated with the physical location. For example, the online system 140 provides 370 the report illustrated in FIG. 4 to a user associated with the content item associated with the physical location, allowing the user to review information describing the effectiveness of the content item at inducing users to visit the physical location and to check-in to the physical location after being presented with the content item. In various embodiments, the report is provided 370 to an online system user associated with the physical location or associated with a content item associated with the physical location to inform the user of changes in foot traffic near the physical location and attributes of online system users who visited a geographic area within the threshold distance of the physical location.

In some embodiments, the online system 140 provides 370 the report to a user associated with a content item presented by the online system 140 who is also associated with a business located at the physical location to identify certain characteristics shared by users who were near the business. For example, the report is communicated to a client device 110 of an owner of a store located at the physical location to identify an age group and a gender most frequently associated with users who visited geographic areas within a threshold distance of the store during particular times of day. As an example, the online system 140 provides 370 the user with the report illustrated in FIG. 9 to inform the user that a majority of users who were within a threshold distance of the user's store during a month prior to a current date were male users between the ages of 35-44. In other embodiments, the report is provided 370 to a user associated with a content item presented by the online system 140 and a business located at the physical location to identify changes in foot traffic of online system users within a threshold distance of the business. For example, the report is provided 370 to an online system user from which a content item associated with a restaurant located at the physical location was received 300, informing the user of the days and times of day during which a maximum amount of users of the group were within a threshold distance of the restaurant. In this example, the online system 140 may provide 370 the user with a report as illustrated in FIGS. 10 and 11 to inform the user that a maximum number of users were associated with geographic locations within the physical location of the restaurant during a past month is from 10:00 AM to 11:00 AM, and that a maximum amount of users of the group were associated with locations within the threshold distance of the physical location of the restaurant on Saturdays during the past month.

The report may also be provided 370 to a user associated with a business located at the physical location to identify attributes of online system users likely to be interested in content items associated with the business, in some embodiments. For example, the online system 140 provides 370 the report to an administrator of a page maintained by the online system 140 and associated with a retail store located at the physical location that identifies attributes associated with at least a threshold amount of users of the group. Based on the attributes identified by the report, the administrator may specify targeting criteria for various content items so the content items are eligible for presentation to users having one or more of the attributes identified by the report, increasing a likelihood that users presented with the content items will interact with the presented content items or perform other actions (e.g., visiting the retail store) when presented with the content items. For example, the online system 140 provides 370 the administrator with a report indicating a majority of users associated with locations within a threshold distance of the retail store during the weekends are female users who live within two miles of the store, so the administrator provides the online system 140 with content items relating to a weekend event at the store that includes targeting criteria identifying attributes indicating users are female and live within two miles of the retail store.

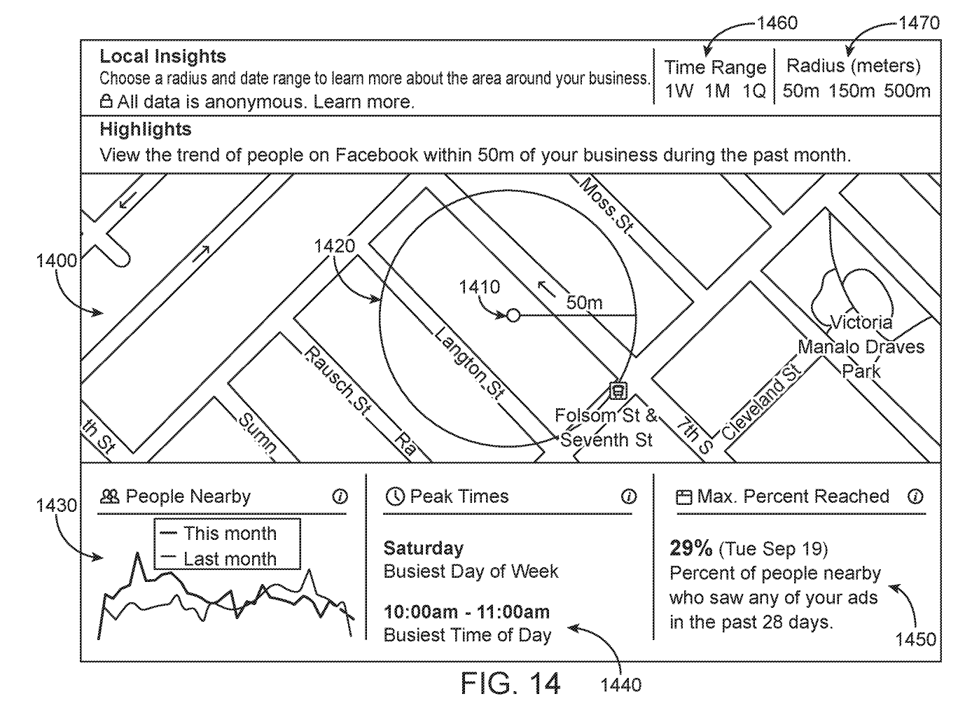

In various embodiments, the report provided 370 to the user associated with the physical location or associated with content item associated with the physical location includes a graphical user interface for presenting the information included in the report to the user via a client device 110 associated with the user. FIG. 14 shows an example graphical user interface displaying a map 1400 of the physical location 1410 and a geographic area within the threshold distance 1420 of the physical location 1410, and an amount 1430 of users of the group who were within the threshold distance 1420 of the physical location 1410 during a current month and during a past month. Additionally, the graphical user interface shown in FIG. 14 includes a time interval 1440 during which a maximum amount of the users of the group were within the threshold distance 1420 of the physical location 1410 and a percentage 1450 of the users of the group who were presented with a content item associated with the physical location 1410.

The graphical user interface allows the user to whom it is provided 370 to display various aspects and formats of the generated data on a client device 110 by interacting with various navigational elements of the graphical user interface. For example, the administrator of the previous example may click various text boxes included in a graphical user interface comprising the generated report to display different charts, graphs, icons, or tables describing different attributes associated with the users of the group or different characteristics of times users where associated with geographic locations within the threshold distance 1420 of the physical location 1410 of the retail store. As another example, the user is presented with the report illustrated in FIG. 5 describing the group of users based on an attribute identifying an age of the users and interacts with selectable radio buttons 510 and icons 520 included in the graphical user interface of the report to display information describing various attributes associated with users of the group or to toggle between the representation of the information shown in FIG. 5 and the alternative representation of the information shown in FIG. 12A.

In some embodiments, the graphical user interface allows a user to whom the report is provided 370 to request a display of information describing different groups or subgroups of the group of users who were within the threshold distance 1420 of the physical location 1410 during different time intervals. For example, as illustrated in FIG. 14, the graphical user interface comprises selectable text boxes 1460 that allow the user to request display of information describing different subgroups of the group of users who were within the threshold distance 1420 of the physical location 1410 during a prior week, during a prior month, and during a prior quarter by selecting a corresponding text box 1460. The graphical user interface may also allow a user to whom the report is provided 370 to view information describing different groups or subgroups of the group of users who were within various threshold distances of the physical location 1410 during various time intervals. In the example of FIG. 14, the graphical user interface includes selectable text boxes 1470 allowing the user to request presentation of information describing different subgroups of the group of users who visited geographic areas within a radius of 50 meters, a radius of 150 meters, and a radius of 500 meters of the physical location 1410 during a particular time interval by clicking on a corresponding text box 1470.

In some embodiments, the graphical user interface included in the report allows the user to display data generated by the online system 140 describing performance of a specific content item presented by the online system 140 during the time interval. For example, the online system 140 provides 370 the user with the report illustrated in FIG. 13B, which describes the group of users based on performance of various content items presented by the online system 140 to users of the group, and the user selects a particular content item 1330 presented to users of the group to display information 1340 describing an amount of compensation received by the online system 140 in exchange for presenting the content item, an amount of online system users who were presented with the content item, and a number of interactions performed by online system users with the content item.

The graphical user interface may also allow the user to whom the report is provided 370 to submit a request to the online system 140 to present a content item associated with the physical location 1410 to additional online system users based on information included in the report (e.g., by interacting with the graphical user interface of the report), in some embodiments. For example, referring to FIG. 10, the user may interact with a hyperlinked text box 1020 included in the graphical user interface of the report to submit a request to the online system 140 to present a content item to online system users having attributes matching least a threshold number of attributes of users of the group who were within the threshold distance 1420 of the physical location 1410 during a time interval 1010 in which a maximum number of users were associated with geographic locations within the threshold distance 140 of the physical location 1410. The graphical user interface may also allow the user to whom the report is provided 370 to submit a request to the online system 140 to modify targeting criteria associated with a particular content item so the targeting criteria specifies one or more attributes of users of the group based on information provided in the report, in some embodiments. Hence, the user to whom the report is presented 370 may modify targeting criteria of one or more content items so the one or more content items are eligible for presentation to users having at least a threshold amount of attributes matching attributes of the group of users described in the report. This may increase a likelihood of a content item being presented to users who are likely to perform a particular action in response to being presented with the content item, such as visiting the physical location 1410 associated with the content item.

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, from a client device associated with a user of an online system, location information describing a geographic location of the client device, a time associated with the geographic location, and identifying information identifying the user to the online system;
storing the received information in association with the user identified by the identifying information at the online system;
identifying a group of users of the online system associated with geographic locations of client devices that were within at least a threshold distance of a physical location associated with a content item maintained by the online system during a specified time interval based on the stored information;
retrieving a set of attributes maintained by the online system and associated with each user of the group of users;
generating a report describing the group of users, the report including one or more attributes associated with at least a threshold amount of users of the group of users based at least in part on the generated data; and
providing the report to a client device associated with an additional user of the online system associated with the content item maintained by the online system for presentation.

2. The method of claim 1, wherein the report describing the group of users comprises a description of visits by users of the group of users to a geographic area within at least the threshold distance of the physical location associated with the content item maintained by the online system during the specified time interval.

3. The method of claim 2, wherein the description of visits by users of the group of users to the geographic area comprises a number of visits by a user of the group of users to the geographic area during the specified time interval.

4. The method of claim 2, wherein the description of visits by users of the group of users to the geographic area comprises a time of a visit by a user of the group of users to the geographic area.

5. The method of claim 1, wherein the report describing the group of users comprises a description of the one or more attributes associated with at least the threshold amount of users of the group of users.

6. The method of claim 1, wherein an attribute associated with at least the threshold amount of users of the group of users is selected from a group consisting of: an age, a gender, a hometown, a workplace, and any combination thereof.

7. The method of claim 1, wherein an attribute associated with at least the threshold amount of users of the group of users is selected from a group consisting of: a presentation of the content item by the online system to a user of the group of users, an interaction with the content item by a user of the group of users, a connection between a user of the group of users and another user of the online system, a connection between a user of the group of users and an object on the online system, and any combination thereof.

8. The method of claim 1, wherein an attribute associated with at least the threshold amount of users of the group is selected from a group consisting of: a presentation of an additional content item by the online system to a user of the group of users, an interaction with the additional content item by the user of the group of users, and any combination thereof.

9. The method of claim 1, wherein the report describing the group of users describes a presentation of the content item maintained by the online system to at least one user of the group of users.

10. The method of claim 1, wherein the report describing the group of users comprises a graphical user interface configured to receive an interaction by the additional user via the client device associated with the additional user to display information describing one or more aspects of the generated data on the client device associated with the additional user.

11. The method of claim 1, wherein the physical location associated with the content item maintained by the online system comprises a physical location for purchasing a product or service associated with the content item.

12. A method comprising:
receiving, from a client device associated with a user of an online system, location information describing a geographic location of the client device, a time associated with the geographic location, and information identifying the user to the online system;
storing the received information in association with the user identified by the location information at the online system;
identifying a group of users of the online system associated with geographic locations of client devices that were within a threshold distance of a specified physical location during a specified time interval based at least in part on the stored information;
retrieving a set of attributes maintained by the online system and associated with at least a threshold amount of users of the group of users; and
generating a report describing one or more attributes of the set of attributes based at least in part on the received location information and one or more characteristics of the one or more attributes.

13. The method of claim 12, wherein the specified physical location is associated with a content item maintained by the online system.

14. The method of claim 13, further comprising:
providing the report to a client device associated with an additional user of the online system associated with the content item for presentation.

15. A computer program product comprising a computer readable storage medium having instructions encoded thereon that, when executed by a processor, cause the processor to:
receive, from a client device associated with a user of an online system, location information describing a geographic location of the client device, a time associated with the geographic location, and identifying information identifying the user to the online system;
store the received information in association with the user identified by the identifying information at the online system;
identify a group of users of the online system associated with geographic locations of client devices that were within at least a threshold distance of a physical location associated with a content item maintained by the online system during a specified time interval based on the stored information;
retrieve a set of attributes maintained by the online system and associated with each user of the group of users;
generate a report describing the group of users, the report including one or more attributes associated with at least a threshold amount of users of the group of users based at least in part on the generated data; and
provide the report to a client device associated with an additional user of the online system associated with the content item maintained by the online system for presentation.

16. The computer program product of claim 15, wherein the report describing the group of users comprises a description of visits by users of the group of users to a geographic area within at least the threshold distance of the physical location associated with the content item maintained by the online system during the specified time interval.

17. The computer program product of claim 16, wherein the description of visits by users of the group of users to the geographic area comprises a number of visits by a user of the group of users to the geographic area during the specified time interval.

18. The computer program product of claim 16, wherein the description of visits by users of the group of users to the geographic area comprises a time of a visit by a user of the group of users to the geographic area.

19. The computer program product of claim 15, wherein the report describing the group of users comprises a description of the one or more attributes associated with at least the threshold amount of users of the group of users.

20. The computer program product of claim 15, wherein an attribute associated with at least the threshold amount of users of the group of users is selected from a group consisting of:
an age, a gender, a hometown, a workplace, and any combination thereof.

21. The computer program product of claim 15, wherein an attribute associated with at least the threshold amount of users of the group of users describes one or more selected from a group consisting of: a presentation of the content item by the online system to a user of the group of users, an interaction with the content item by a user of the group of users, a connection between a user of the group of users and another user of the online system, a connection between a user of the group of users and an object on the online system, and any combination thereof.

22. The computer program product of claim 15, wherein the report describing the group of users describes a presentation of the content item maintained by the online system to at least one user of the group of users.

23. The computer program product of claim 15, wherein the physical location associated with the content item maintained by the online system comprises a physical location for purchasing a product or service associated with the content item.
